(19) United States
(12) Patent Application Publication
(10) Pub. No.: US 2008/0242409 A1
(43) Pub. Date: Oct. 2, 2008

(54) Video Feed Synchronization in an Interactive Environment

(75) Inventor: Darren Schueller, Oceanside, CA (US)

Correspondence Address: FISH & RICHARDSON, PC, P.O. BOX 1022, MINNEAPOLIS, MN, 55440-1022, US

(73) Assignee: NTN BUZZTIME, INC., Carlsbad, CA (US)

(21) Appl. No.: 12/060,127

(22) Filed: Mar. 31, 2008

Related U.S. Application Data
(60) Provisional application No. 60/909,337, filed on Mar. 30, 2007.

(51) Int. Cl. A63F 13/00

(52) U.S. Cl. 463/31

(57) ABSTRACT

Interactive environments can include operating an interactive game in which a video feed is distributed to a plurality of locations, determining a time offset for at least one of the locations based on a delay of the video feed to the at least one location, and accepting game responses from the at least one location based on the time offset for the location.

### CLAIM OF PRIORITY

This application claims priority under 35 U.S.C. 119(e) to U.S. Patent Application Ser. No. 60/909,337, filed on Mar. 30, 2007, the entire contents of which are hereby incorporated by reference.

### TECHNICAL FIELD

This application relates to video feed synchronization in an interactive environment.

### BACKGROUND

Interactive environments can include multiple game players interacting with a main controller and watching a video feed. The game players submit game responses in response to what they see on a video feed. The game players can be dispersed across multiple locations.

### SUMMARY

This specification describes technologies that, among other things, synchronize the delivery of a real-time video feed to multiple locations to an interactive environment.

In general, the subject matter described can be implemented in methods that include operating an interactive game in which a video feed is distributed to a plurality of locations, determining a time offset for at least one of the locations based on a delay of the video feed to the at least one location, and accepting game responses from the at least one location based on the time offset for the location. Other implementations can include corresponding systems, apparatus, and computer program products.

This, and other aspects, can include one or more of the following features. Determining the time offset can include identifying the delay for a medium over which the video feed is distributed to the at least one location. Some implementations can include determining a local time for an event that occurred in the video feed; and determining a remote time for the at least one location that denotes a time when the event occurred in the video feed received at the location, wherein determining the time offset includes calculating a difference between the local time and the remote time. Some implementations can include receiving a frame captured from the video feed at the at least one location and a timestamp indicating a captured time of when the frame was captured, wherein the frame defines the event, wherein the captured time defines the remote time. Some implementations can include receiving responses from the location for the event. Some implementations can include determining a peak time that identifies a peak rate of received responses; and using the peak time to determine the remote time. A received response can include a guess of a future play of a ball game. A received response can include an indication that a person appeared on the video feed. A received response can include a timestamp of when the response was made, wherein determining the remote time comprises using the timestamps of at least a portion of the received responses. Some implementations can include determining an ending time for accepting game responses; and adjusting the ending time for accepting responses from the at least one location by the time offset for the location to produce an adjusted ending time, wherein accepting games responses from the at least one location includes accepting game responses from the location until the adjusted ending time. Adjusting the ending time can include extending the ending time by the time offset for the at least one location. Some implementations can include transmitting the adjusted ending time for the at least one location to a remote processing unit at the location, wherein the remote processing unit accepts game responses up until the adjusted ending time for the location.

The subject matter described can also be implemented in methods that include operating an interactive game in which a video feed is distributed to a plurality of locations; determining a time offset for at least one of the locations based on a delay of the video feed to the at least one location; determining an ending time for accepting responses; adjusting the ending time for accepting responses from the at least one location by the time offset for the at least one location to produce an adjusted ending time; and accepting game responses from the at least one location until the adjusted ending time.

Particular implementations of the subject matter described in this specification can be implemented to realize one or more of the following potential advantages. The time offset can be used to compensate for the delay in transmitting a video feed to a location. Such delay compensation can allow game players at a first location to fairly compete with game players at a second location, wherein the delays to the first and second locations are different.

The details of one or more implementations are set forth in the accompanying drawings and the description below. Other features, aspects, and advantages will become apparent from the description, the drawings, and the claims.

### BRIEF DESCRIPTION OF THE DRAWINGS

FIG. 1 shows an example of a video feed distribution environment.

FIG. 2 shows an example of an interactive gaming environment distributed over multiple locations.

FIG. 3 shows another example of an interactive gaming environment distributed over multiple locations.

FIG. 4 shows an example of a flowchart of a synchronization process.

FIGS. 5A-C show multiple examples of obtaining sync information from a location.

FIG. 6 shows another example of a synchronization process.

Like reference symbols and designations in the various drawings indicate like elements.

### DETAILED DESCRIPTION

Interactive environments can include processor electronics such as a main controller that coordinates game play based on a video feed distributed to multiple locations. Interactive environments can be of a time sensitive nature. For example, game players of an interactive environment can be given a window of time in which to submit game responses or given until a lockout time to submit game responses. In some responses, game players submit game responses based on a video feed. Because game players can be located at multiple locations in which the video feed is received at different times, the delay between the locations can be compensated for in order to fairly score the game responses between the locations.

An interactive environment can include a real-time style game, in which game players attempt to guess what will happen in a real-time program. For example, a game can be a sports-based game such as football. In one such sports-based game, like football, the game players can attempt to guess the play that will be made by the team at the next play time. The offense walks to the line of scrimmage, and based on the way the offense stands, the game players can guess what kind of play will come after that. A game player can submit a game response indicating a future play. Game responses can be locked out before the play starts to avoid anyone receiving an unfair advantage. However, it can be advantageous to allow game players to see the sports players up to the last second, at the line of scrimmage, so that they can make the best guesses. The game player with the correct guess can win the game.

Therefore, such an interactive environment can synchronize the game with the football “snap” at the moment of the snap in order to determine a lockout time for accepting game responses.

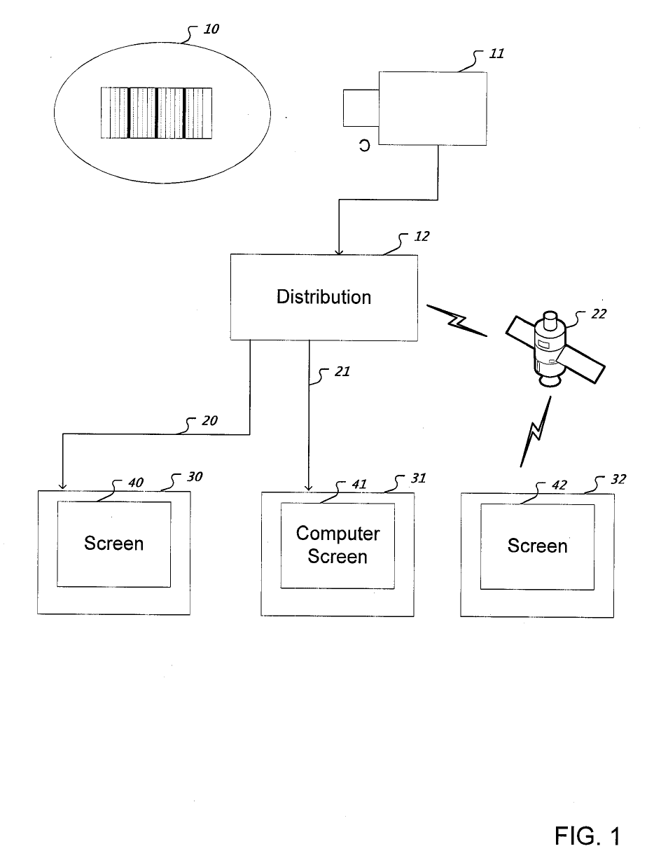

FIG. 1 shows an example of a video feed distribution environment. A video camera 11 can capture live video of a sporting event 10 such as football. The video feed from the video camera 11 can be distributed 12 to one or more locations 30, 31, 32 via one or more broadcast pathways such as cable 20, Internet 21, and satellite 22. The video feed can be displayed, for example, on a television 40 connected to cable 20, a computer screen 41 that receives an output from a computer connected to the Internet 21, or a monitor 42 connected to a satellite receiver to receive a satellite signal 22.

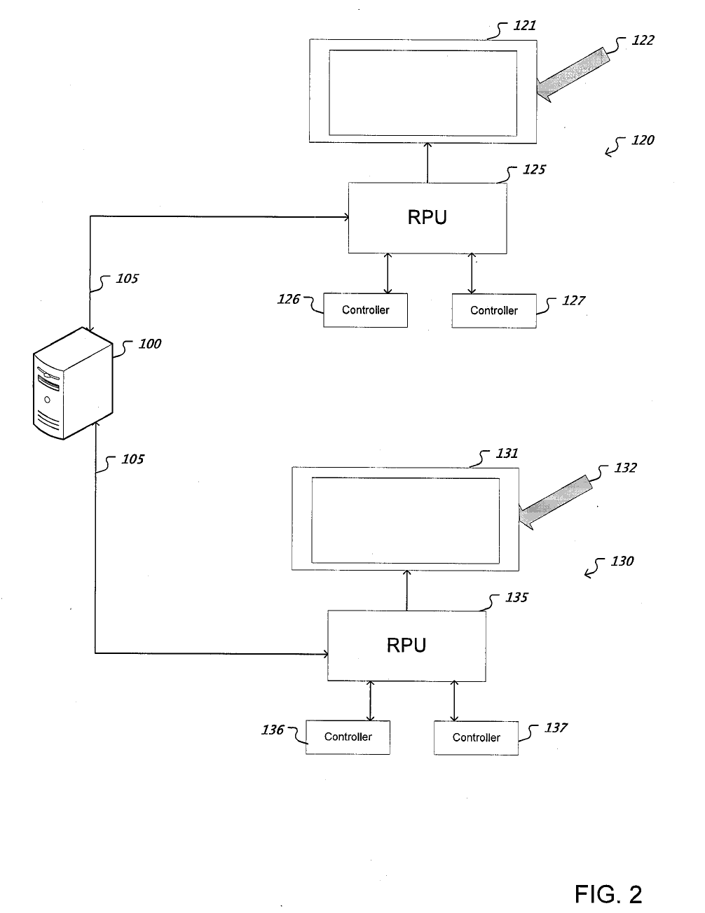

FIG. 2 shows an example of an interactive gaming environment distributed over multiple locations. Processor electronics such as a main controller 100 can be located at a specific location, such as the main headquarters of a game provider. The main controller 100 can interact with one or more different gaming locations 120, 130 via communication pathways 105. Communication pathways 105 can include the Internet, local area networks, wide area networks, and wireless networks.

Two different gaming locations 120, 130 are shown in FIG. 2. The first location 120 can include a television 121 which receives a video feed via cable 122. A remote processing unit (RPU) 125 can interact with the main controller 100 via communication pathway 105. The RPU 125 can include processor electronics. In some implementations, the RPU can be a set-top box (STB). In some implementations, the RPU can be a computer. The RPU 125 can interact with one or more local game controllers 126, 127. A person playing the game can enter a game response through a game controller 126, 127. There can be one or more local controllers interacting with the RPU 125. In addition, the RPU 125 can be integrated with the television 121, and can be a cable card form, or can take any other form.

The second location 130 can include a television 131. The feed to television 131 can be from a satellite feed 132. In some implementations, the television can include a monitor linked to a separate receiver. A RPU 135 can interact with the main controller 100 via communication pathway 105. The RPU 135 can interface with one or more controllers 136, 137. Other locations which are not shown can also exist. Any of these locations can receive the video feed over any means. For example, the video feed can be distributed over mediums that include broadcast television, TV over internet or other mediums for delivering video feed.

In addition, game players can be located at the actual sporting venue from which the feeds 122, 132 are derived.

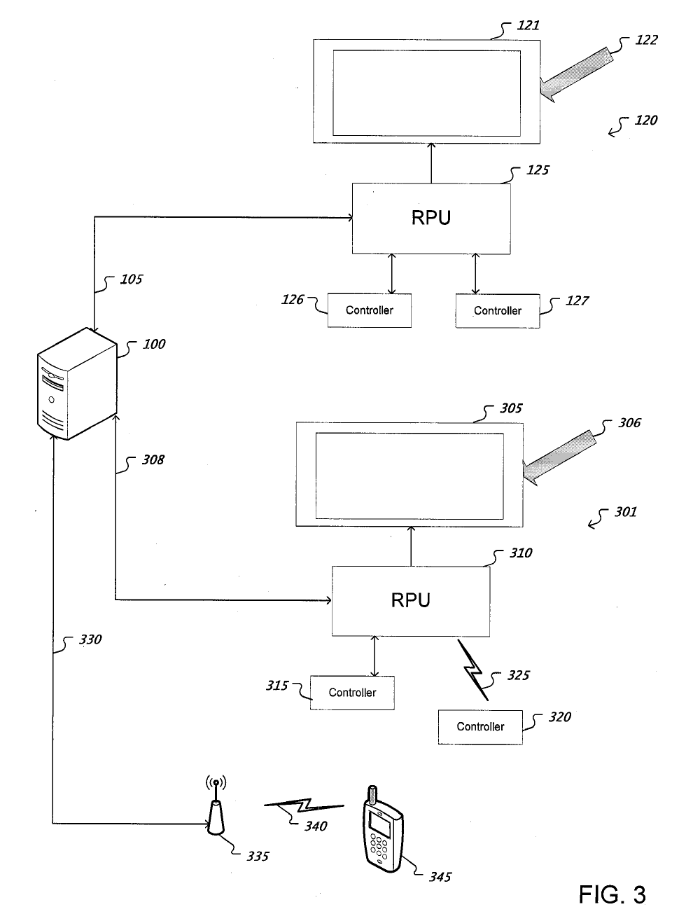

FIG. 3 shows another example of an interactive gaming environment distributed over multiple locations. Location 301 can include a television 305 receiving a viedo feed 306 of the sporting event. The RPU 310 can communicate to the main controller 100 via communication pathway 308. The RPU 310 can interact with one or more game controllers such as a wired game controller 315 and a wireless game controller 320 via a wireless signal 325. A mobile device, such as a mobile phone 345, can participate in the interactive gaming environment by communicating with the main controller 100. The mobile phone 345 can connect to the main controller 100 via a wireless network through a wireless signal 340. The wireless network can include a wireless communication tower 335 and a communication pathway 330 between the tower 335 and the main controller 100.

The delay between the real-time game and a video feed can be, for example, between 0 seconds and 10 seconds. In other examples, the delay can be between 3 and 5 seconds, and can be different depending on the medium being used, as well as the distance from the main hub or headquarters.

A main controller can perform a synchronization process between gaming locations such as locations 120, 130. The synchronization process can include determining a difference between a local time of a location, and the real-time operation, or more generally, a time that the main controller designates. The difference can include a component reflecting the delay of the video feed to the location.

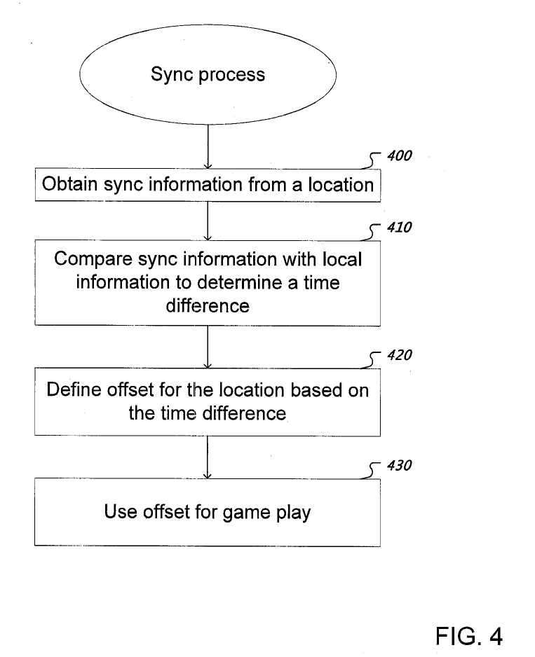

FIG. 4 shows an example of a flowchart of a synchronization (sync) process. The main controller 100 can obtain 400 sync information from a specific location such as locations 120, 130, or some other location. The sync information can include an identification of a sync event. For example, a sync event can be a snap of a ball as shown in the video feed or when a sports player appears in the video feed. In some implementations, sync information can include a time that a specified sync event occurred.

The main controller can compare 410 sync information with local information to determine a time difference. In some implementations, the sync information can be compared with the local information to determine a difference between the time that the main controller thinks that the sync event occurred, and the time that the sync event is produced by the RPU. Local information can include a time, i.e., the local sync event time, that the main controller detected the occurrence of the sync event. The time that the remote controller detected the occurrence of the sync event can be called the remote sync event time.

The main controller can define 420 an offset for the location based on the time difference. In some implementations, the difference between the local sync event time and the remote sync event time can be defined as an offset for the location. The main controller can use 430 the offset for further game play.

In one aspect, an attempt can be made to avoid any latency from the network connection such as connection 105. Accordingly, the sync event can be determined by using synchronized clocks in the main controller 100 and a RPU such as RPUs 125, 135. When the sync event occurs, the time of the local clock can be captured. That local clock time can then be sent back to the main controller, to allow a comparison of the different clock times. Similarly, the main controller can determine a clock time for a lockout, and can send that clock time to the RPU. The RPU can receive and process game responses until the clock time for the lockout. It is possible that the clock time can be received after the real clock time. In that event, game responses which are received after the clock time can be retroactively deactivated, and the game player can receive a message such as “Sorry, your guess was too late.” The main controller can reset the lockout for the next round of game responses.

In some implementations, the system can operate directly over network connections and can assume that network latency will be the same at all times.

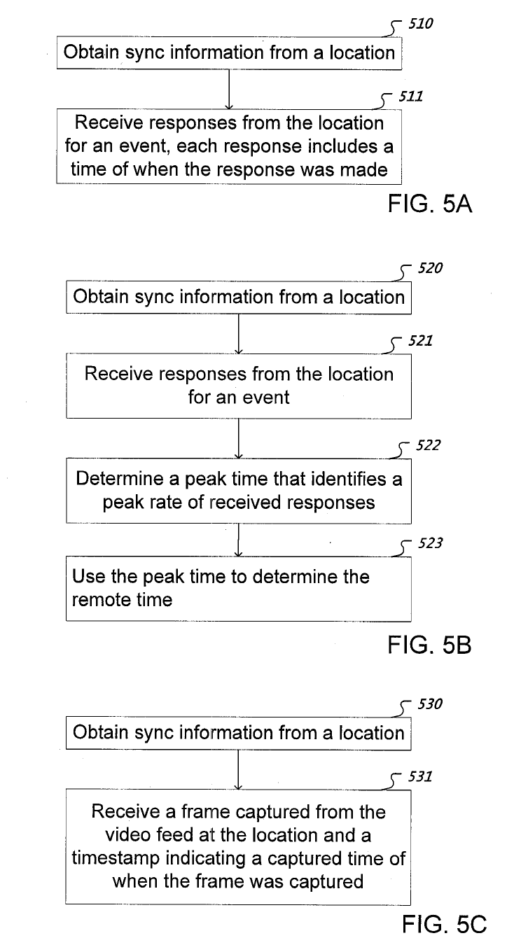

The main controller 100 can obtain 400 sync information from a specific location such as locations 120, 130, or some other location. Multiple techniques can used to obtain sync information as shown in FIGS. 5A-C. The system can use one or more techniques or a combination of different techniques to obtain or determine sync information for the locations.

FIG. 5A shows a technique where sync information is obtained 510 from a location can include receiving 511 responses from the location. Each response can include a time of when the response was made. In some implementations, the main controller can generate a message asking one or more game players to generate a user sync response. The message can be displayed on a monitor at the location. For example, a game player can be asked to press a specified button such as a button on a game controller at a specified time during a game. A RPU can display a message on a monitor or TV asking for a response. For example, the message can include the following language: “when you see the player come on the field, please press your start button.” In some implementations, a game player can be asked to press a button on his game controller at the moment he sees an event from the video feed. For example, the event can be the moment when the kicker's foot strikes the ball during the opening kickoff of the football game. The time the start button is pressed can become the remote time. The sync response can include an indication of the button press and an indication of the time when the button press occurred. On the main controller, the remote time can be compared with the local time, to form a time offset. That time offset, once determined, can remain in effect for the entire game or can be reset during the game.

In some implementations, multiple user sync responses can be used to determine the remote time. For example, for location 120, synchronization can be established when three or more sync responses are received in which the responses agree to a remote local within a specified amount. In some implementations, the sync responses can be averaged to calculate the remote time. In some implementations, the received sync responses can be used to determine a delay to timestamp data packets according to that delay.

The timing profile of game responses can be used to determine a remote time for a location. Using an example of interactive game based on a football game, such as the QB1 game, available from NTN Buzztime of Carlsbad, Calif., it has been noted statistically that there are spikes of activity from players at different times during the real-time play. For example, as the players approach the line of scrimmage, some people begin making guesses, but the level of activity is at a maximum right at the snap of the ball. This time of spike in activity can peak as a Gaussian function at the same time for each play.

The game response activity can be used to determine a timestamp. Thus, another technique shown in FIG. 5B where sync information is obtained 520 from a location can include receiving 521 responses from the location for an event, determining 522 a peak time that identifies a peak rate of received responses, and using 523 the peak time to determine the remote. It can be assumed that the spike in activity occurs at the same time, relative to the video feed of the play, for one or more locations. That spike in activity can be used to define a time offset which relates to the actual snap of the ball. A latency monitor can be used to determine the activity spike.

Some implementations can allow a game player to perform synchronization using, for example, a mobile phone. Thus, another technique shown in FIG. 5C where sync information is obtained 530 from a location can include receiving 531 a frame captured from the video feed at the location and a timestamp indicating a captured time of when the frame was captured. For example, the game player can take a picture of the screen displaying the video feed which. The picture can be associated with a timestamp indicative of when the picture was taken. The game player can use a mobile device such as a mobile phone with a camera to take the picture. The picture can then be sent to the main controller, which can match the timestamp of the image, the frame of the image, with analogous frames and times on the main controller. From that, the system can determine the timestamp which represents the actual latency, and can use that timestamp to synchronize with the actual timing.

The system can use a default delay for the video feed's mode of transmission. In some implementations, a delay model can be based on what kind of system, e.g. cable, satellite, internet, is used in viewing the video feed. For example, a site receiving the video feed over cable can be assigned a default cable delay value and a different site receiving the video feed over satellite can be assigned a default satellite delay value.

Some implementations can allow each game player to individually assess his own delay, and data with multiple different timestamps can be sent directly to the individual sites or game players. A concern with this embodiment, however, is that game players can band together or individually try to cheat. Another implementation can attempt to automatically find this information in a way which can reduce the possibility of cheating.

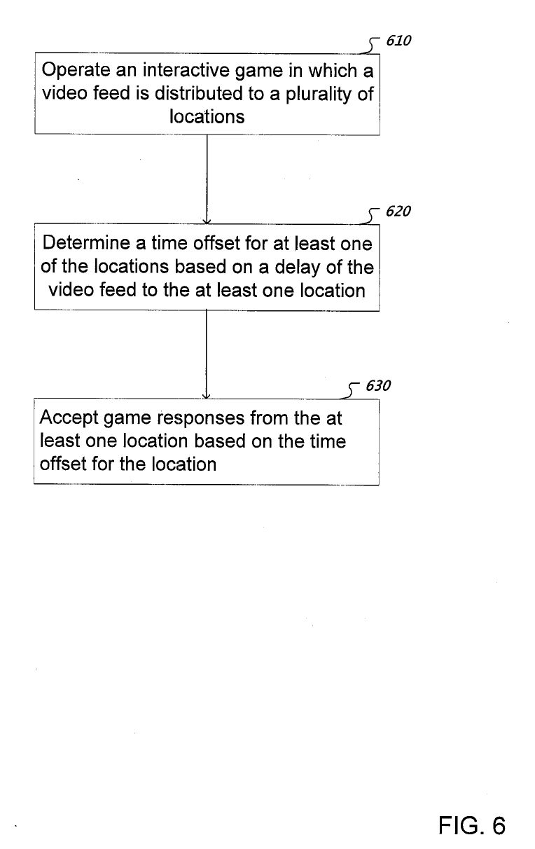

FIG. 6 shows another example of a synchronization process. The main controller can operate 610 an interactive game in which a video feed is distributed to a plurality of locations. The main controller can determine 620 a time offset for at least one of the locations based on a delay of the video feed to the at least one location. The main controller can accept 630 game responses from the at least one location based on the time offset for the location.

In some implementations, multiple synchronization techniques can be used. For example, if the main controller cannot determine the broadcast mode of the video feed to a location, then the main controller can determine the remote time for the location through the techniques that including receive responses or data from game player. For the other sites that that the main controller can determine the broadcast mode, the default mode's delay value can be used.

Implementations of the subject matter and the functional operations described in this specification can be implemented in digital electronic circuitry, or in computer software, firmware, or hardware, including the structures disclosed in this specification and their structural equivalents, or in combinations of one or more of them. Implementations of the subject matter described in this specification can be implemented as one or more computer program products, i e., one or more modules of computer program instructions encoded on a computer readable medium for execution by, or to control the operation of, data processing apparatus. The computer readable medium can be a machine-readable storage device, a machine-readable storage substrate, a memory device, a composition of matter effecting a machine-readable propagated signal, or a combination of one or more of them. The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal, that is generated to encode information for transmission to suitable receiver apparatus.

A computer program (also known as a program, software, software application, script, or code) can be written in any form of programming language, including compiled or interpreted languages, and it can be deployed in any form, including as a stand alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs., or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio player, a Global Positioning System (GPS) receiver, to name just a few. Computer readable media suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, implementations of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, near-tactile, or tactile input.

Implementations of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described is this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

While this specification contains many specifics, these should not be construed as limitations on the scope of the disclosure or of what may be claimed, but rather as descriptions of features specific to particular implementations of the disclosure. Certain features that are described in this specification in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

Thus, particular implementations of the disclosure have been described. Other implementations are within the scope of the following claims. For example, the functionally of the main controller can be distributed between multiple processors.

What is claimed is:

1. A method comprising:
operating an interactive game in which a video feed is distributed to a plurality of locations;
determining a time offset for at least one of the locations based on a delay of the video feed to the at least one location; and
accepting game responses from the at least one location based on the time offset for the location.

2. The method of claim 1, wherein determining the time offset comprises identifying the delay for a medium over which the video feed is distributed to the at least one location.

3. The method of claim 1, comprising:
determining a local time for an event that occurred in the video feed; and
determining a remote time for the at least one location that denotes a time when the event occurred in the video feed received at the locations wherein determining the time offset comprises calculating a difference between the local time and the remote time.

4. The method of claim 3, comprising:
receiving a frame captured from the video feed at the at least one location and a timestamp indicating a captured time of when the frame was captured, wherein the frame defines the event, wherein the captured time defines the remote time.

5. The method of claim 3, comprising:
receiving responses from the location for the event.

6. The method of claim 5, comprising:
determining a peak time that identifies a peak rate of received responses; and
using the peak time to determine the remote time.

7. The method of claim 5, wherein each received response comprises a guess of a future play of a ball game.

8. The method of claim 5, wherein each received response comprises an indication that a person appeared on the video feed.

9. The method of claim 5, wherein each received response comprises a timestamp of when the response was made, wherein determining the remote time comprises using the timestamps of at least a portion of the received responses.

10. The method of claim 1, comprising:
determining an ending time for accepting game responses; and
adjusting the ending time for accepting responses from the at least one location by the time offset for the location to produce an adjusted ending time,
wherein accepting games responses from the at least one location comprises accepting game responses from the location until the adjusted ending time.

11. The method of claim 10, wherein adjusting the ending time comprises extending the ending time by the time offset for the at least one location.

12. The method of claim 10, comprising:
transmitting the adjusted ending time for the at least one location to a remote processing unit at the location, wherein the remote processing unit accepts game responses up until the adjusted ending time for the location.

13. A method comprising:
operating an interactive game in which a video feed is distributed to a plurality of locations;
determining a time offset for at least one of the locations based on a delay of the video feed to the at least one location;
determining an ending time for accepting responses;
adjusting the ending time for accepting responses from the at least one location by the time offset for the at least one location to produce an adjusted ending time; and
accepting game responses from the at least one location until the adjusted ending time.

14. A computer program product, tangibly embodied on a computer-readable medium, the computer program product comprising instructions to enable data processing apparatus to perform operations comprising:
operating an interactive game in which a video feed is distributed to a plurality of locations;
determining a time offset for at least one of the locations based on a delay of the video feed to the at least one location; and
accepting game responses from the at least one location based on the time offset for the location.

15. The computer program product of claim 14, wherein determining the time offset comprises identifying the delay for a medium over which the video feed is distributed to the, at least one location.

16. The computer program product of claim 14, comprising:
determining a local time for an event that occurred in the video feed; and
determining a remote time for the at least one location that denotes a time when the event occurred in the video feed received at the location, wherein determining the time offset comprises calculating a difference between the local time and the remote time.

17. The computer program product of claim 16, comprising:
receiving a frame captured from the video feed at the at least one location and a timestamp indicating a captured time of when the frame was captured, wherein the frame defines the event, wherein the captured time defines the remote time.

18. The computer program product of claim 16, comprising:
receiving responses from the location for the event.

19. The computer program product of claim 18, comprising:
determining a peak time that identifies a peak rate of received responses; and
using the peak time to determine the remote time.

20. The computer program product of claim 18, wherein each received response comprises a guess of a future play of a ball game.

21. The computer program product of claim 18, wherein each received response comprises an indication that a person appeared on the video feed.

22. The computer program product of claim 18, wherein each received response comprises a timestamp of when the response was made, wherein determining the remote time comprises using the timestamps of at least a portion of the received responses.

23. The computer program product of claim 14, comprising:
determining an ending time for accepting game responses; and
adjusting the ending time for accepting responses from the at least one location by the time offset for the location to produce an adjusted ending time,
wherein accepting games responses from the at least one location comprises accepting game responses from the location until the adjusted ending time.

24. The computer program product of claim 23, wherein adjusting the ending time comprises extending the ending time by the time offset for the at least one location.

25. The computer program product of claim 23, comprising:
transmitting the adjusted ending time for the at least one location to a remote processing unit at the location, wherein the remote processing unit accepts game responses up until the adjusted ending time for the location.

26. A system comprising:
a processor; and
a computer-readable medium encoding instructions to cause the processor to perform operations comprising:
operating an interactive game in which a video feed is distributed to a plurality of locations;
determining a time offset for at least one of the locations based on a delay of the video feed to the at least one location; and
accepting game responses from the at least one location based on the time offset for the location.

27. The system of claim 26, wherein determining the time offset comprises identifying the delay for a medium over which the video feed is distributed to the at least one location.

28. The system of claim 26, comprising:
determining a local time for an event that occurred in the video feed; and
determining a remote time for the at least one location that denotes a time when the event occurred in the video feed received at the location, wherein determining the time offset comprises calculating a difference between the local time and the remote time.

29. The system of claim 28, comprising:
receiving a frame captured from the video feed at the at least one location and a timestamp indicating a captured time of when the frame was captured, wherein the frame defines the event, wherein the captured time defines the remote time.

30. The system of claim 28, comprising:
receiving responses from the location for the event.

31. The system of claim 30, comprising:
determining a peak time that identifies a peak rate of received responses; and
using the peak time to determine the remote time.

32. The system of claim 30, wherein each received response comprises a guess of a future play of a ball game.

33. The system of claim 30, wherein each received response comprises an indication that a person appeared on the video feed.

34. The system of claim 30, wherein each received response comprises a timestamp of when the response was made, wherein determining the remote time comprises using the timestamps of at least a portion of the received responses.

35. The system of claim 26, comprising:
determining an ending time for accepting game responses; and
adjusting the ending time for accepting responses from the at least one location by the time offset for the location to produce an adjusted ending time,
wherein accepting games responses from the at least one location comprises accepting game responses from the location until the adjusted ending time.

36. The system of claim 35, wherein adjusting the ending time comprises extending the ending time by the time offset for the at least one location.

37. The system of claim 35, comprising:
transmitting the adjusted ending time for the at least one location to a remote processing unit at the location, wherein the remote processing unit accepts game responses up until the adjusted ending time for the location.
